(19) United States
(12) Patent Application Publication
(10) Pub. No.: US 2017/0061089 A1
(43) Pub. Date: Mar. 2, 2017

(54) OPTIMIZATION OF ALARM SETTINGS FOR ALARM CONSULTANCY USING ALARM REGENERATION

(71) Applicant: KONINKLIJKE PHILIPS N.V., EINDHOVEN (NL)

(72) Inventors: Stijn De Waele, Millwood, NY (US); Larry Nielsen, Burlington, MA (US); Lin Yang, Chandler, AZ (US)

(73) Assignee: KONINKLIJKE PHILIPS N.V., EINDHOVEN (NL)

(21) Appl. No.: 15/119,915

(22) PCT Filed: Mar. 3, 2015
(86) PCT No.: PCT/IB2015/051530

§ 371 Date: Aug. 18, 2016

Related U.S. Application Data
(60) Provisional application No. 61/953,126, filed on Mar. 14, 2014.

(51) Int. Cl. G06F 19/00

(52) U.S. Cl. CPC G06F 19/3406; G06F 19/3431

(57) ABSTRACT

A system (38) and a method (150) for optimization of alarm settings of a clinical alarm algorithm. Clinical monitoring data (CMD) employed by the clinical alarm algorithm is acquired over a user-defined period of time. Proposed settings are determined for one or more parameters of the clinical alarm algorithm. The clinical monitoring algorithm is applied to the acquired CMD with the proposed settings to determine regeneration results predicting alarm load for different combinations of the proposed settings.

The present application relates generally to patient monitoring. It finds particular application in conjunction with optimization of alarm settings, and will be described with particular reference thereto. However, it is to be understood that it also finds application in other usage scenarios and is not necessarily limited to the aforementioned application.

Patient monitors contribute to patient safety by raising an alarm in the presence of abnormal vital signs that indicate patient deterioration. Several modalities have been introduced to routine intensive care unit (ICU) care throughout the second half of the 20^{th} century, resulting in the rich monitoring landscape existing today. These modalities include electrocardiogram (ECG), peripheral capillary oxygen saturation (SpO2), blood pressure, and respiratory rate monitoring. With the availability of more monitoring modalities comes the challenge of proper alarm configuration to reduce false and clinically insignificant alarms, while retaining alarms of clinical significance, especially those associated with clinical events and episodes. This applies both to single parameter alarms and to more advanced multi-parameter alarms.

In 1994, a study found that over 94% of alarm soundings in a pediatric ICU may not be clinically important. Similar results have been found since in different studies throughout the years. For example, the ECRI Institute ranked alarm hazards as the second greatest health technology hazard in 2011 and the greatest health technology hazard in 2012 and 2013. In response to this broadly experienced hazard, The Joint Commission has initiated a patient safety goal on alarm management for 2014, requiring hospitals to improve their alarm management.

A proposed method for improving alarm management includes using multi-parameter alarm algorithms. Traditional alarm algorithms are single-parameter. Multi-parameter alarm algorithms offer greater sensitivity and specificity. An example of a multi-path alarm algorithm is an alarm algorithm based on an early warning score (EWS) system or one of its variants. Another proposed method for improving alarm management includes performing large patient trials to determine appropriate default settings. However, this proposed method suffers from a knowledge gap in that there are no studies on the proper settings for alarm thresholds. Another proposed method for improving alarm management includes site-specific interventional trials for local optimization of alarm strategies.

With the large variation between hospitals, hospital wards, and hospital critical care units in patient population, nurse-to-patient ratio and both quality and quantity of monitoring equipment, it is expected that site-specific interventional trials for local optimization of alarm strategies will remain important as the other proposed methods are implemented. This is because the patient population and their vital signs characteristics varies significantly across units. The interventional trial is typically organized into three stages: pre-intervention; intervention; and post-intervention. In the pre-intervention stage, alarms for a set of patients are recorded, the most frequent alarms are identified, and a proposed alarm strategy (e.g., alarm threshold, alarm severity, etc.) is defined. In the intervention stage, the proposed alarm strategy is applied to a new set of patients. In the post-intervention stage, alarms for the new set of patients are recorded. The post- and pre-intervention alarm datasets are then compared to draw conclusions on the effectiveness and safety of the proposed alarm strategy.

A challenge with performing a site-specific interventional trial is that there is no accurate prediction for the impact of the proposed alarm strategy on alarm load, work flow, and patient safety. As such, the quality of the proposed new alarm strategy is limited. Further, the lack of a prediction regarding patient safety poses a risk to patient safety during the post-intervention stage.

Another challenge with performing a site-specific interventional trial is that the post-intervention stage is typically long. The proposed alarm strategy is applied to a new set of patients, which introduces a significant source of variance in estimating the reduction in alarm load. Therefore, a relatively long post-intervention stage is needed to draw statistically significant conclusions.

Another challenge with performing a site-specific interventional trial is expense. The post-intervention stage is expensive because of regulatory approval, training of personnel, and progress and safety monitoring. Also, definition of the proposed alarm strategy in the first-intervention stage is expensive because it requires physician hours to agree on new settings. Nonetheless, relative to the post-intervention stage, the pre-intervention stage is inexpensive and without impact on workflow.

The present application provides a new and improved system and method which overcome these problems and others.

In accordance with one aspect, a system for optimization of alarm settings of a clinical alarm algorithm is provided. The system includes an acquisition module configured to acquire clinical monitoring data (CMD) employed by the clinical alarm algorithm over a user-defined period of time. The system further includes a regeneration module configured to determine proposed settings for one or more parameters of the clinical alarm algorithm and apply the clinical monitoring algorithm to the acquired CMD with the proposed settings to determine regeneration results predicting alarm load for different combinations of the proposed settings.

In accordance with another aspect, a method for optimization of alarm settings of a clinical alarm algorithm. The method includes acquiring clinical monitoring data (CMD) employed by the clinical alarm algorithm over a user-defined period of time, determining proposed settings for one or more parameters of the clinical alarm algorithm, and applying the clinical monitoring algorithm to the acquired CMD with the proposed settings to determine regeneration results predicting alarm load for different combinations of the proposed settings.

In accordance with another aspect, a system for optimization of alarm settings of a clinical alarm algorithm is provided. The system includes means for receiving clinical monitoring data (CMD) employed by the clinical alarm algorithm over a user-defined period of time, means for determining proposed settings for one or more parameters of the clinical alarm algorithm, and means for applying the clinical monitoring algorithm to the acquired CMD with the proposed settings to determine regeneration results predicting alarm load for different combinations of the proposed settings.

One advantage resides in an accurate prediction for the impact of a proposed alarm strategy.

Another advantage resides in improved patient safety.

Another advantage resides in reduced expense and duration compared to an interventional trial.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

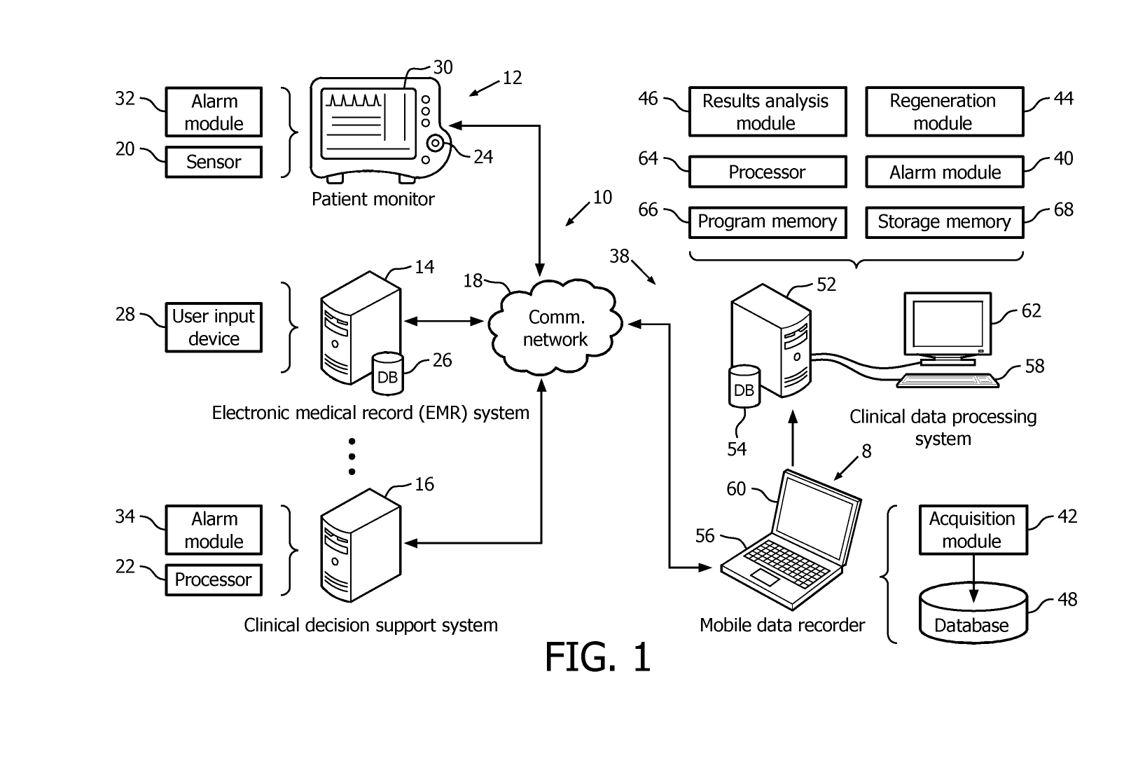

FIG. 1 illustrates an information technology (IT) infrastructure of a medical institution, along with an alarm generation system.

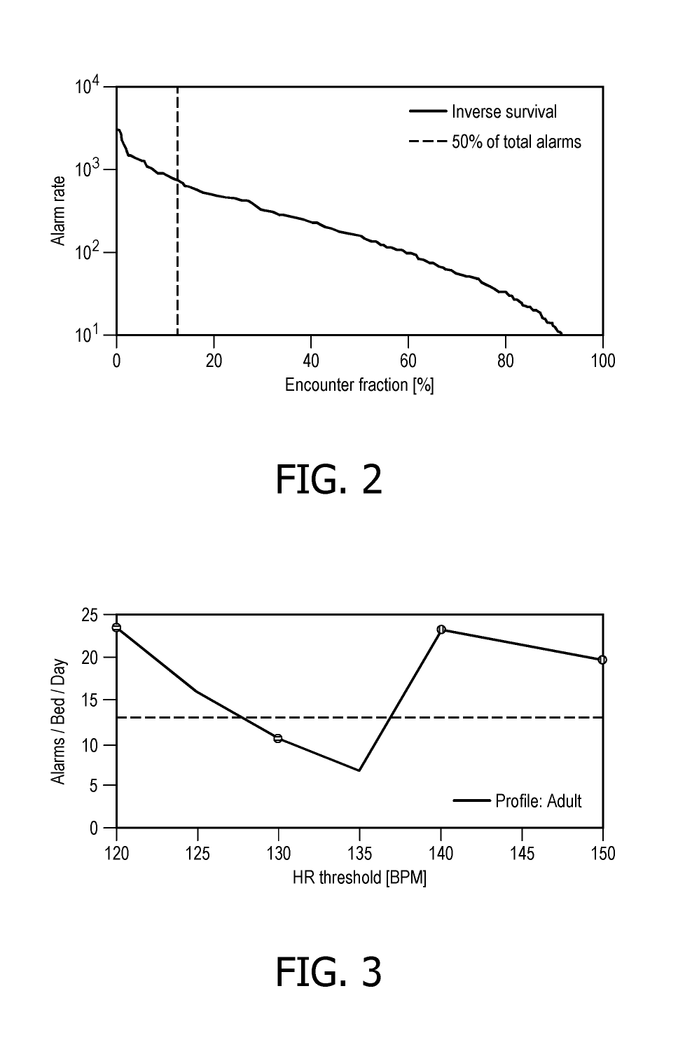

FIG. 2 illustrates a graph of alarm count as a function of encounter fraction.

FIG. 3 illustrates a graph of alarm load in terms of alarms per bed per day as a function of alarm threshold.

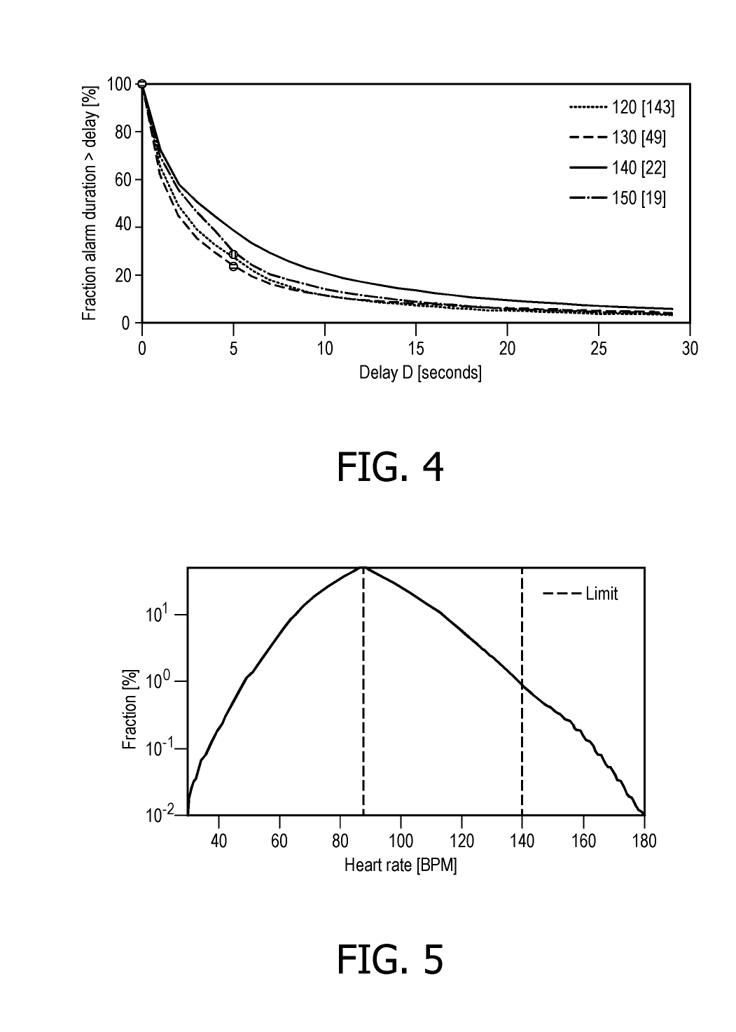

FIG. 4 illustrates a graph of percentage of alarms with durations greater than delay as a function of delay for various alarm thresholds.

FIG. 5 illustrates a cumulative histogram describing the fraction of time an alarm threshold is met across a patient population for each of a plurality of heart rate bin.

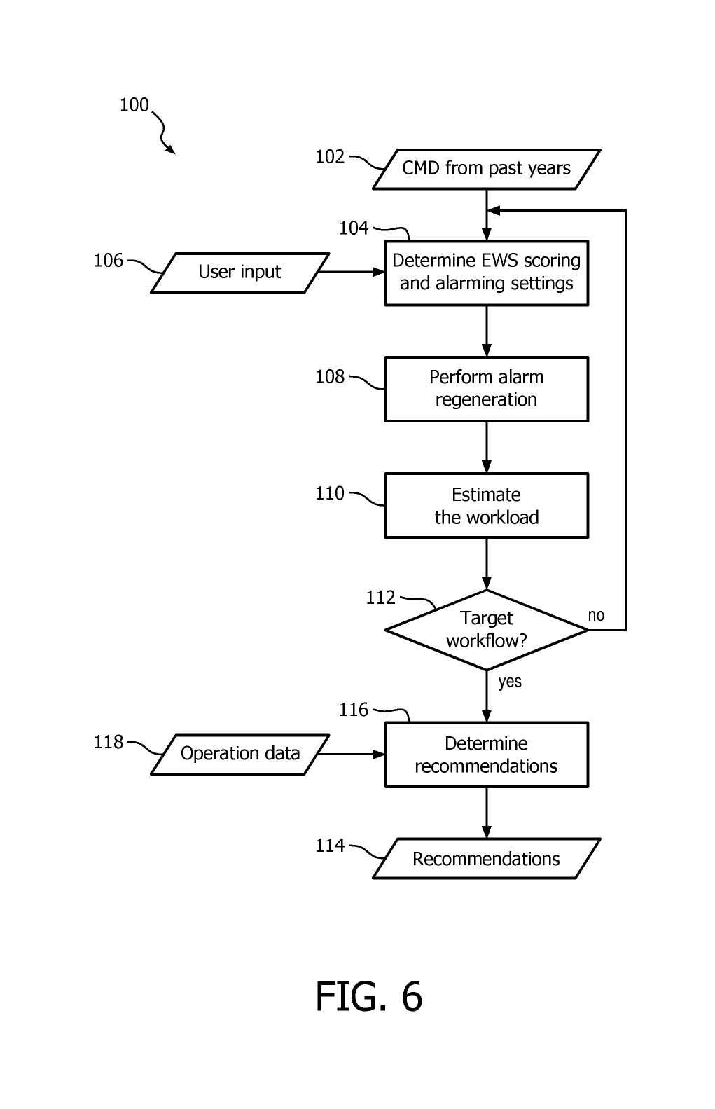

FIG. 6 illustrates a flowchart of alarm regeneration with an early warning score (EWS) system.

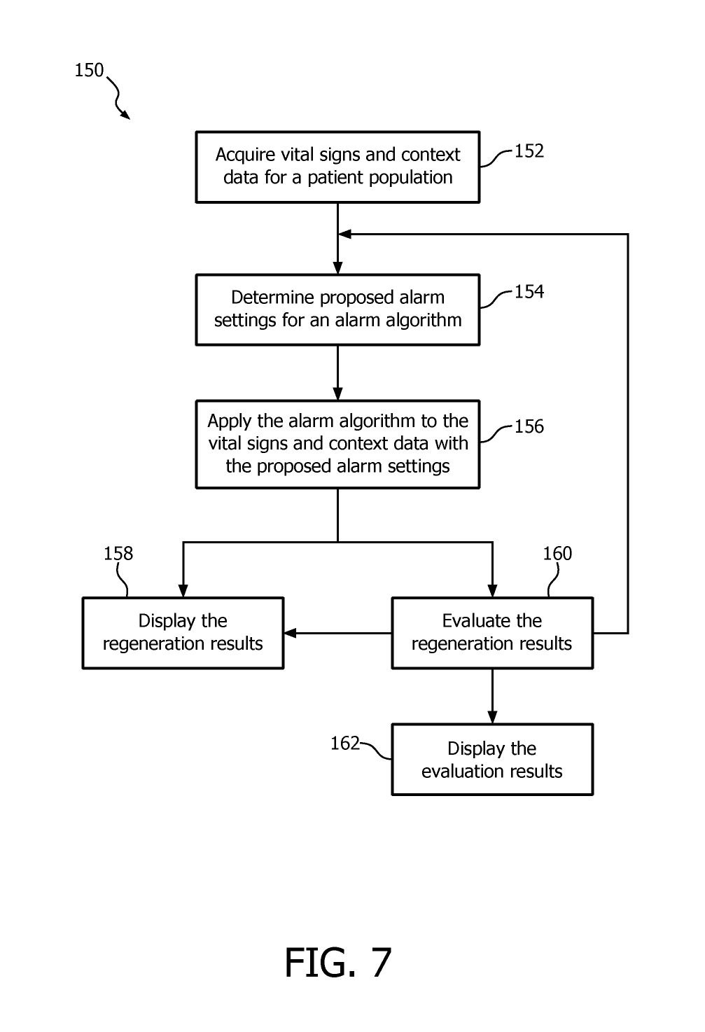

FIG. 7 illustrates a method for optimization of alarm settings using alarm regeneration.

The present application discloses an approach for optimizing alarm settings. According to the approach, vital signs and context data are recorded over a period of time. Alarms are then regenerated based on the recorded data for several proposed alarm settings. The regeneration allows alarm load and related parameters, such as the work load impact and detection performance (i.e., sensitivity and specificity), to be accurately predicted for the specific patient population of the recorded data.

With reference to FIG. 1, an information technology (IT) infrastructure 10 of a medical institution includes one or more sources 12, 14, 16 of clinical monitoring data (CMD) connected through a communications network 18. The communications network 18 is typically a local area network (LAN), but other types of communications networks are contemplated. CMD is any data used by a clinical monitoring algorithm (CMA) to generate an alarm in response to detecting patient deterioration. Examples of CMD sources 12, 14, 16 include, but are not limited to, patient monitors 12, nursing stations, mobile communications devices, patient information systems 14, clinical decision support systems 16, and so on.

The CMD sources 12, 14, 16 store or generate CMD for corresponding patients. The CMD for a patient includes data indicative of the physiological state of the patient. Data indicative of the physiological state of a patient includes data indicative of vital signs (e.g., heart rate, electrocardiogram (ECG), blood pressure, peripheral capillary oxygen saturation (SpO2), etc.), lab tests (e.g., creatine, blood urea nitrogen (BUN), alanine aminotransferase (ALT), etc.), physiological scores (e.g., early warning score (EWS), vital signs instability index (VIX), simplified acute physiology score (SAPS)-I, etc.), fluids, demographics (e.g., age, gender, etc.), alarms, and other variables relevant to the physiological state of the patient (e.g., diagnosis, intensive care unit (ICU) type, etc.).

A CMD source 12, 16 generating CMD is a CMD producer 12, 16. A CMD producer 12, 16 typically generates CMD continuously or upon the happening of an event, such as a timer event, a user input event, and so on. Further, a CMD producer 12, 16 generates CMD automatically or manually. A CMD producer 12, 16 can generate CMD automatically by, for example, measuring a variable indicative of the physiological state of a patient with a sensor 20 or by calculating a value indicative the physiological state of the patient with a processor 22. A CMD producer 12, 16 can generate CMD manually by, for example, receiving user input indicative of the physiological state of a patient from a clinician with a user input device 24. Examples of CMD producers 12, 16 include, but are not limited to, patient monitors 12, and clinical decision support systems 16.

A CMD source 14 storing CMD is a CMD store 14. A CMD source can be both a CMD producer 12, 16 and a CMD store 14. A CMD store 14 stores CMD locally in a database 26. The CMD stored can be received locally or remotely. For example, the CMD can be received remotely from other CMD sources 12, 16 or can be received locally from a user with a user input device 28. Examples of CMD stores 14 include, but are not limited to, electronic medical record (EMR) systems 14, departmental systems, and the like.

The CMD sources 12, 14, 16 and the alarm modules 32, 34 are each one of software, hardware, or a combination of the two. Where a CMD source 12, 14, 16 or alarm module 32, 34 includes or is software, the CMD source 12, 14, 16 or the alarm module 32, 34 typically includes or is associated with, respectively, at least one processor 22 and at least one program memory. The at least one processor 22 executes processor executable instructions on the at least one program memory to carry out the functionality of the CMD source 12, 14, 16 or the alarm module. Similarly, where a CMD source 12, 14, 16 or alarm module 32, 34 receives user input or displays data, the CMD source 12, 14, 16 typically includes or is associated with a user input device 24, 28 or a display device 30, respectively.

Typically, the CMD sources 12, 14, 16 include at least one CMD producer 12, 16 of alarm data. A CMD producer 12, 16 of alarm data is associated with one or more patients and includes a clinical monitoring algorithm implemented in an alarm module 32, 34. The clinical monitoring algorithm monitors the patients for patient deterioration based on received CMD. In response to detecting patient deterioration, the clinical monitoring algorithm generates an alarm. The clinical monitoring algorithm receives the CMD locally (e.g., by a user input device 24) or remotely (e.g., from another CMD source 12, 14, 16). Examples of CMD producers 12, 16 of alarm data include patient monitors 12, clinical decision support systems 16, and the like.

Clinical monitoring algorithms can be categorized by the way the algorithms are configured. In that vein, at least three different classes of clinical monitoring algorithms exist: tunable alarm algorithms, on/off alarm algorithms, and threshold alarm algorithms. Tunable alarm algorithms trigger an alarm when a non-vital sign (e.g., sleep apnea duration) exceeds a user-defined threshold. On/off alarm algorithms trigger an alarm when a binary physiological parameter (e.g., premature ventricular beat (PVC)) indicates an “on” state. Such on/off alarm algorithm may or may not have user-adjustable parameters. Threshold alarm algorithms trigger an alarm when a vital sign (e.g., heart rate) exceeds a user-defined threshold.

A threshold alarm algorithm can include filtering mechanisms to reduce the alarm rate. One such filtering mechanism is a delay mechanism in which a triggered alarm is suppressed if it lasts less than a user-defined number of seconds. Another such filtering mechanism is an inhibition mechanism in which a triggered alarm is suppressed if there was an alarm of the same type in the last user-defined number of seconds.

With continued reference to FIG. 1, the IT infrastructure 10 further includes an alarm regeneration system 38. The alarm regeneration system 38 optimizes alarm settings of a clinical monitoring algorithm for a user-defined patient population of the medical institution. The clinical monitoring algorithm is implemented by an alarm module 40 of the alarm regeneration system 38. An alarm setting refers to a value of a user-defined parameter of the clinical monitoring algorithm or a related algorithm (e.g., an algorithm providing input to the clinical monitoring algorithm, such as a EWS algorithm). The user-defined parameters of a threshold alarm algorithm include, for example, threshold, delay and inhibition period. The user defined patient population can, for example, be a user-defined set of one or more medical units or wards within the medical institution. The clinical monitoring algorithm can be implemented within the CMD sources 12, 14, 16 of the IT infrastructure 10, or within the alarm regeneration system 38.

The alarm regeneration system 38 acquires and stores CMD, including vital signs and context data, required by the clinical monitoring algorithm for the user-defined patient population from the CMD sources 12, 14, 16 over a user-defined period of time (e.g., two weeks or six months). The alarm settings for the clinical monitoring algorithm are then optimized through alarm regeneration. More specifically, alarms are regenerated through application of the clinical monitoring algorithm to the stored CMD with several different alarm settings. The regeneration results are then assessed to accurately predict the effect that the different alarm settings have on alarm load and related parameters, such as the work load impact and detection performance (i.e., sensitivity and specificity), for the user-defined patient population. To carry out the foregoing, the alarm regeneration system 38 includes a plurality of modules: an acquisition module 42; a regeneration module 44; and a results analysis module 46.

The acquisition module 42 acquires CMD from the CMD sources 12, 14, 16 over the communications network 18 for the user-defined period of time and stores the acquired data in a mobile database 48. The CMD includes vital signs for the user-defined patient population and further context data required by the clinical monitoring algorithm. Context data includes, for example, data describing lab results and patient diagnosis. The CMD can further include one or more of: data describing triggered alarms; data regarding patient deterioration, such as recorded clinical events regarding patient deterioration (e.g., deterioration-related interventions) or patient care level increases; and data regarding recorded or estimated workload per alarm-triggered intervention. The acquisition module 42 acquires the CMD at a sufficient sample rate for the clinical monitoring algorithm, such as a one second sampling rate for vital signs.

Typically, the acquisition module 42 and the mobile database 48 are included within a mobile data recorder 50 of the alarm regeneration system 38. Before beginning acquisition of CMD, the mobile data recorder 50 is installed at the medical institution. For example, the mobile data recorder is connected directly to the communications network 18, or indirectly to the communications network 18 by way of another device or system. Once installed, the CMD is acquired by the acquisition module 42 and stored in the mobile database 48 for the user-defined period.

Upon conclusion of the acquisition, the mobile data recorder 50 is uninstalled from the medical institution and physically transported to a central data processing system 52 of the alarm generation system 38. The central data processing system 52 is typically located remote from the medical institution. After removal of Protected Health Information, the central data processing system 52 then downloads the data to a central database 54 and locally processes the data in the central database 54 with the other modules 44, 46, as discussed below. As an alternative to employing the central data processing system 52, the mobile data recorder 50 can locally process the data in the mobile database 48 with the other modules 44, 46, as discussed below.

Regardless of where the data acquired by the acquisition module 42 is processed, the regeneration modules 44 next coordinates with the alarm module 40 to regenerate alarms through application of the clinical monitoring algorithm to the acquired CMD for the user-defined patient population for each setting of a set of proposed alarm settings. This allows accurate prediction of alarm load and related parameters as a function of proposed alarm settings. Typically, the proposed alarm settings are applied without regard for modifications made to corresponding alarm setting parameters by clinicians during acquisition. However, in some embodiments, the proposed alarm settings are only used to the extent that no such modifications to the corresponding alarm setting parameters are made during acquisition.

A proposed alarm setting is typically generic to the entire user-defined patient population and determined before regeneration. However, a proposed alarm setting can alternatively be dependent upon the CMD and determined during regeneration. For example, a proposed alarm setting can be determined per patient based on CMD about the patient, such as diagnosis, age, or lab results. As another example, a proposed alarm setting can be determined per vital sign sample of a patient based upon current vital sign values of the patient.

The proposed alarm settings can be manually, automatically, or both automatically and manually defined for the alarm setting parameters of the clinical monitoring algorithm or a related algorithm. As to manual definition of the proposed alarm settings, a user input device 56, 58 can, for example, be employed to manually define the proposed alarm settings. This is advantageous for scenarios in which a clinician or a panel of clinicians determines proposed alarm settings. As to the automatic definition of the proposed alarm settings, the parameter space of each of the user-defined parameters of the clinical monitoring algorithm can, for example, be uniformly sampled. Alternatively, an algorithm can determine the propose alarm settings based on the CMD or feedback from the results analysis module 46.

Although the acquisition is configured to acquire vital sign and context data, situations may arise where only alarm data is available. In such instances, approximate alarm regeneration can be performed. More specifically, approximate alarm regeneration can be performed by applying the proposed alarm thresholds to the extremes of the alarms. A characteristic of this technique is that the results show the combination effect of vital sign values and alarm settings during acquisition. This approximation is known to work well when the clinical monitoring algorithm is a pure threshold alarm algorithm (i.e., a threshold alarm algorithm without any filtering mechanisms).

The results analysis module 46 receives the regeneration results from the regeneration module 44 and graphically displays the regeneration results with a display device 60, 62 to a clinician for evaluation. The regeneration results can be displayed in graphs illustrating the predicted alarm displayed per alarm type and aggregated in different ways, such as per alarm severity, per modality, per shift, etc. Further, the regeneration results can be displayed in graphs illustrating the predicted alarm load or a related parameter (e.g., workload or alarm rate) as a function of one or more alarm setting parameters.

In addition to display the regeneration results, the results analysis module 46 can automatically evaluate the regeneration results with at least one processor 64 and displays the results of the evaluation with the display device 60, 62. For example, true and false alarm rate can be assessed and the results displayed where patient deterioration data was acquired. Similarly, workload or alarm rate can be estimated and displayed based on the regenerated alarms. In some embodiments, the results analysis module 46 provides feedback to the regeneration module 44 based on the evaluation results until a set of one or more objectives are achieved. In providing the feedback, the proposed alarm settings are continuously modified or tuned until the set of objectives are achieved. The set of objectives can, for example, include a target workload or alarm rate.

In some embodiments, where the acquired CMD includes alarms, the results analysis module 46 estimates the recorded alarm rate and the regenerated alarm rates for proposed alarm settings. The estimates can then be graphically displayed to allow quantitative comparison. Alternatively, the estimate of the recorded alarms can be automatically compared to the estimates of the regenerated alarms and alarm settings with reductions in alarm rate exceeding a user-defined threshold can be displayed.

Alarm rate r is defined as the expectation of an alarm count c generated by a single patient divided by a time interval t:

$$r = E [ \frac{c}{t} ] , \qquad ( 1 )$$

where r is given in counts per patient per day. To arrive at the alarm rate as experienced by a clinician, the alarm rate r is multiplied by the number of patients under care of the clinician. When partitioning the time interval t into N patient encounters, each i with an encounter alarm rate rᵢ, encounter alarm count c, and an encounter duration (i.e., length of stay) dᵢ, the alarm rate r can be re-written as:

$$r = E [ \frac{{Σc}_{i}}{{Σd}_{i}} ] = E [ \frac{\frac{1}{N} {Σd}_{i} {r}_{i}}{\frac{1}{N} {Σd}_{i}} ] . \qquad ( 2 )$$

The most direct expression for alarm rate r is in terms of the alert count c (i.e., not normalized to an alarm rate). To express the alarm rate r in terms of the encounter alarm rate rᵢ, the encounter alarm rates rᵢ are weighted proportionally by the encounter duration dᵢ. The practical implication is that reducing false alarm rate for a patient with a combination of a high alarm rate and a long length of stay results in the greatest reduction of alarm fatigue.

The alarm rate is estimated by dividing the total alarm count by the sum of encounter durations:

$$\hat{r} = \frac{{Σc}_{i}}{{Σd}_{i}} . \qquad ( 3 )$$

This can be derived from Equation (2). Assuming a Gaussian distribution of the rate estimate, the 95% confidence interval for this estimate is given by [\hat{r}−1.96\hat{σ},\hat{r}−1.96\hat{σ}], where \hat{σ} is the estimated standard deviation, taken here as the square root of the estimated variance \hat{V}.

A starting point for a variance estimator is the sample variance, defined as follows. All encounters are concatenated on the time axis. The time axis is split into equal partitions of length t_{σ}. The alarm rate estimate within partition k is denoted rₜ_{_{σ}}_{,k}, the number of partitions is M. The sample variance \hat{V}_{S} is given by:

$${\hat{V}}_{S} = \frac{1}{M} {{Σ}_{k} ( {r}_{{t}_{σ} , k} - \hat{r} )}^{2} , \qquad ( 4 )$$

which results in the variance estimate \hat{V}*:

$${\hat{V}}^{*} = \frac{1}{{M}^{2}} {{Σ}_{k} ( {r}_{{t}_{σ} , k} - \hat{r} )}^{2} . \qquad ( 5 )$$

Partition boundaries are not aligned with encounter boundaries. This complicates the calculation of \hat{V}*, and also introduces dependencies between the samples. Therefore, each encounter is used as a sample, and its contribution is weighed according to the encounter duration, resulting in the following variance estimate \hat{V}:

$$\hat{V} = \frac{1}{{N}^{2}} {{Σ}_{k} ( {r}_{{t}_{σ} , k} - \hat{r} )}^{2} . \qquad ( 6 )$$

Further, in some embodiments, the results analysis module 46 determines and displays the distribution of alarm rate per encounter. As discussed above, each alarm is associated with an encounter. A useful approach to display the distribution includes plotting the alarm rate as a function of the encounter, where the encounters are ordered from high to low alarm rate. Expressed in basic statistical functions, this is the inverse survival function sᵢₙᵥ:

s^{inv}(p)=X:P(x>X)=p, (7)

where p is the encounter fraction, P(x>X) is the survival function for the alarm rate X (i.e., the probability that x>X). The survival function is the reverse of the cumulative histogram: P(x>X)=1−P(x≦X).

FIG. 2 shows a graph of inverse survival function for alarm count per encounter. The alarm count distribution over patients can be characterized by the fraction of encounters that cause a given fraction of the total alarms. As shown, 50% of the alarms are caused by 12% of encounters with the highest alarm count. This statistic shows the potential alarm rate reduction that can be achieved by addressing the most alarming patients.

The regeneration results describe the predicted alarm load of the user-defined patient population. The results analysis module 46 can extend the regeneration results to predict the alarm load of a future patient population. More specifically, the CMD can be analyzed to determine a distribution of different patient types within the user-defined patient populations. Further, a distribution of different patient types can be defined for the future patient. The distributions can then be compared and the regeneration results can be reweighted. Patient types more prevalent in the future distribution are given more weight in the reweighted regeneration results than patient types more prevalent in the user-defined distribution. For example, if the user-defined patient population contains more geriatric patients than the average patient population, alarms for geriatric patients could be reduced to estimate regeneration results for an average patient population.

Advantageously, with alarm regeneration, the impact of a new alarm strategy can be quantified before new alarm settings are applied to new patients. More specifically, because the various settings are applied to the same patient population, the alarm load reduction can be calculated with great accuracy. Unlike methods where recorded alarms or alarm thresholds are used, the regeneration results are independent of the alarm settings that were active during the data collection.

As discussed above, the regeneration system 38 includes a plurality of modules 40, 42, 44, 46. Each of the modules 40, 42, 44, 46 is one of software, hardware, or a combination of the two. Where a module 40, 42, 44, 46 includes or is software, the module 40, 42, 44, 46 typically includes or is associated with, respectively, at least one processor 64 and at least one program memory 66. The at least one processor 64 executes processor executable instructions on the at least one program memory 66 to carry out the functionality of the module 40, 42, 44, 46. Similarly, where a module 40, 42, 44, 46 receives user input or displays data, the module 40, 42, 44, 46 typically includes or is associated with a user input device 56, 58 or a display device 60, 62, respectively.

Also, as discussed above, the regeneration system 38 includes at least one database 48, 54. Each of the at least one database 48, 54 is one of software, hardware, or a combination of the two. Where a database 48, 54 includes or is software, the database 48, 54 typically includes or is associated with, respectively, at least one storage memory 68 storing the data of the database 48, 54.

While the alarm regeneration system 36 is illustrated as including a mobile data recorder 50 and a central data processing system 38, it is to be appreciated that components of the central data processing system 38 can be integrated with the mobile data recorder 50. These components includes the alarm, regeneration and results analysis modules 40, 44, 46 and, in some embodiments, the at least one processor 64 and the program and storage memories 66, 68. Advantageously, by integrating the components of the central data processing system 38 with the mobile data recorder 50, the alarm settings of the medical institution can be optimized on site.

To illustrate operation of the regeneration system 38, applicants hereafter describe two illustrative embodiments. According to the first illustrative embodiment, suppose the clinical monitoring algorithm is a threshold alarm algorithm with delay and inhibition filtering mechanisms. The threshold alarm algorithm can, for example, be employed by a patient monitor 12 of the IT infrastructure 10. In applying the alarm regeneration system 38 to the first embodiment, the acquisition module 42 is employed to record vital signs for the user-defined patient population to the mobile database 48. The vital signs are sampled at a rate to allow accurate regeneration with the threshold alarm algorithm.

Subsequent to acquisition, the regeneration module 44 is employed to perform alarm load prediction by applying the threshold alarm algorithm to the recorded vital signs with proposed alarm settings. Typically, the proposed alarm settings are generic to the entire user-defined patient population. Because the threshold alarm algorithm includes delay and inhibition filtering mechanism, there are three alarm setting parameters for which settings can be optimization: a threshold Th, a delay D, and an inhibition period I. As discussed above, the delay filtering mechanism suppresses a triggered alarm if it lasts less than the delay D, and an inhibition filtering mechanism suppresses a triggered alarm if there was an alarm of the same type in the immediately preceding inhibition period I.

To perform regeneration on a threshold alarm algorithm with delay and inhibition filtering, it is beneficial to perform the alarm regeneration in separate stages, rather than repeating the complete regeneration for each different setting. According to the first stage, proposed alarm settings for the threshold Th are evaluated. This includes, for each proposed alarm setting for the threshold, determining the time intervals over the user-defined period where the vital sign exceeds the proposed alarm setting. These times intervals represent regenerated alarms and are stored for subsequent use.

With the first stage complete, second and third stages derive the alarm load for different delays and inhibition periods, respectively, by filtering the regenerated alarms, without the need to reanalyze the vital sign over the entire user-defined period. Advantageously, this significantly accelerates the regeneration. According to the second stage, for each proposed alarm setting for the delay, the regenerated alarms where (EndTime−AnnounceTime)<D are removed. According to the third stage, for each proposed alarm setting for the inhibition period, the remaining regenerated alarms n where EndTimeₙ<EndTimeₙ₊₁+T are removed.

Upon completion of regeneration, the results analysis module 46 receives the foregoing results and displays the results to a clinician. FIGS. 3-5 provide example displays of results when the threshold alarm algorithm is applied to heart rate. The alarm threshold is in terms of beats per minute (BPM).

With reference to FIG. 3, a graph of alarm load in terms of alarms per bed per day as a function of the alarm threshold is illustrated. The dashed line represents the median. The increase from threshold 135 to threshold 140 is because alarm thresholds of 140 and up are treated as critical level alarms (represented by vertically striped circles), which have no inhibition. Conversely, lower level, urgent alarms (represented by horizontally striped circles) have a default inhibition period of three minutes, which lowers the alarm load.

Suppose the alarm threshold is increased from 120 to 130, thereby increasing the lower level, urgent alarm threshold to 130. Further, suppose the difference between the critical level alarm threshold and the lower level, urgent alarm threshold is maintained at 20. In such a scenario, the critical level alarm threshold is further increased from 140 to 150. These changes result in the following alarm load reductions: lower level, urgent alarms are reduced from 22.8 to 10.1 (i.e., a 55% reduction); and critical level alarms are reduced from 22.5 to 18.7 (i.e., a 17% reduction).

With reference to FIG. 4, a graph of percentage of alarms with durations greater than delay as a function of delay for various alarm thresholds is illustrated. Suppose an increase in delay from zero to five seconds, assuming an alarm threshold of 130. This results in the following alarm load reductions: lower level, urgent alarms are reduced from 100% to 24.3% (i.e., a 75.7% reduction); and critical level alarms are reduced from 100% to 29.9% (i.e., a 70.1% reduction). Similar reductions can be achieved at the default alarm threshold of 120.

With reference to FIG. 5, this figure illustrates a folded cumulative histogram describing the fraction of time an alarm threshold is met across a patient population for each of a plurality of heart rate bin. To facilitate visual evaluation of the distribution, the histogram F is replaced by the survival function 1−F for values greater than the median. For example, it can be determined that the HR is greater than 140 for 0.87% of time, or 31 seconds per hour. With a critical alarm without filtering mechanisms, this fraction is equal to the fraction of time the alarm sounds, and hence gives an indication of the alarm noise level caused by this alarm.

Referring back to FIG. 1, according to the second illustrative embodiment, suppose the clinical monitoring algorithm is a threshold alarm algorithm employing a EWS system. EWS systems are commonly used by clinical monitoring algorithms in general wards. The EWS system calculates a EWS in real time by counting the contributions of several critical physiological parameters according to a EWS model. When the EWS passes one of a plurality of alarm thresholds, an alarm may be triggered and a certain clinical team may be required to respond depending upon the alarm threshold passed.

In applying the alarm regeneration system 38 to the second embodiment, the acquisition module 42 is employed to record the physiological parameters (e.g., level of consciousness) employed by the EWS system. The physiological data can, for example, be drawn from an EMR system 14 over the communications network 18. Further, the physiological data can, for example, include data indicative of any of the following: vital signs; deterioration (e.g., an adverse event, a transfer to a higher level of care, etc.); demographics; lab results; medications; and any other data required by the EWS system. The recorded data is preferably from multiple years so variations between seasons or even years can be considered. However, if such data is limited, a chunk of data from each season is sufficient (e.g., a month-worth of data from each quarter of the year). If the EWS system is integrated in patient monitors 12, high sampling-rate vital signs measured by the patient monitors needs to be similarly recorded at a high sampling rate.

After acquisition, the regeneration module 44 is employed for alarm load prediction by applying the threshold alarm algorithm and the EWS system to the recorded data with proposed alarm settings. The alarm setting parameters considered during alarm regeneration include alarm thresholds, as well as related parameters of the EWS system, such as the EWS model and the responsibilities of different clinical teams. The responsibilities define the correspondence between the alarm thresholds and the different clinical teams. Considering different EWS model settings allows alarm sensitivity and specificity to be tailored to different patient populations. Further, together the responsibilities, the EWS model and the responsibilities determine when and how often floor nurses should check the vital signs of a patient, when a physician or a rapid response team (RRT) should be called, whether a patient needs to be transferred to an ICU, etc.

The results analysis module 46 next evaluates the regeneration results, typically by estimating workload from the regeneration results. The workload estimation results can be displayed and typically include a list of statistics. For example, the list can include the number of alarms that have to be responded to by nurses (e.g., the number of alarms per nurse per day), the number of additional spot checks triggered by low-threshold alarms (e.g., the number of additional spot checks per nurse per day), the number of RRT calls triggered by high-threshold alarms (e.g., the number of RRT calls per day), the number of true positive alarms, the number of false alarms, sensitivity, and specificity, etc. Based on the workload estimation and operation data of the medical institution, the results analysis module 46 can further determine and display cost estimations and recommendations for operations of the medical institution, such as an estimation of seasonal fluctuation in patient populations, plans for staffing, or plans for device purchases or upgrades. The proposed alarm settings can be modified until the proper combination of alarm settings is found. Extending the second embodiment, the proposed alarm settings are continuously refined or tuned until a target workload is achieved. More specifically, regeneration results are generated for an initial proposed alarm settings. These alarm settings are applied by the regeneration module 44 and the results analysis module 46 evaluates the regeneration results to determine whether the target workload is met. To the extent that the target workload is not met, feedback is provided to the regeneration module 44 so revised proposed alarm settings can be evaluated. This continues until the target workload is met. In this way, alarm settings can be optimized.

With reference to FIG. 6, a flow chart 100 summarizes the second embodiment. As seen, patient data 102 from past years is acquired by the acquisition module 42. Thereafter, initial EWS scoring and alarming settings are determined 104 by the regeneration module 44 based on user input 106, typically from a clinician of the medical institution. Alarm regeneration is performed 108 on the settings by the regeneration module 44, and workload is estimated 110 from the regeneration results by the results analysis module 46. A determination 112 is made as to whether a target workload is achieved from the workload estimates. To the extent that the target is not achieved, the EWS scoring and alarming settings are revised or tuned, and regeneration and evaluation are performed again. This repeats until the target workload is achieved. Once the target workload is achieved, recommendations 114 are automatically determined 116 through application of the workload estimate to operation data 118 of the medical institution. The recommendations 114 are then displayed to clinicians.

With reference to FIG. 7, a method 150 for optimization of alarm settings of a clinical alarm algorithm is provided. The method 150 is performed by the modules 40, 42, 44, 46 of the alarm regeneration system 38. According to the method 150, CMD employed by the clinical alarm algorithm is acquired 152 over a user-defined period of time from the IT infrastructure 10. The CMD is acquired for multiple patients of a user-defined patient population at a sufficient sample rate for the application to the clinical alarm algorithm. For example, vital sign data are acquired at a one second sample rate for the user-defined patient population over the user-defined period.

In addition to acquiring the CMD, proposed alarm settings are determined 154 for the configurable parameters of the clinical alarm algorithm and/or related algorithms. A related algorithm is, for example, a scoring system algorithm employed by the clinical alarm algorithm. The proposed alarm settings can be determined automatically, manually, or both automatically and manually. For example, proposed alarm settings can be determined automatically by sampling the parameter space and then the automatically determined settings can be modified by user input. With the determined proposed alarm settings and the acquired CMD, the clinical alarm algorithm is applied 156 to the CMD with the proposed alarm settings to predict alarm load and related parameters for different combinations of the proposed settings.

Where the clinical alarm algorithm is a threshold alarm algorithm, the parameters of the configurable parameters can include threshold, delay and inhibition period. The clinical alarm algorithm is applied 156 with settings for the threshold by, for each proposed setting of the threshold, determining a set of intervals during the user-defined period where the acquired CMD exceeds the proposed setting. These intervals correspond to alarms. The clinical alarm algorithm is applied with settings for the delay or the inhibition period by, for each proposed setting of the delay or the inhibition period, filtering the set of intervals based on the setting.

Where the clinical alarm algorithm is a threshold alarm algorithm employing a scoring system, the parameters of the configurable parameters can include parameters related to the scoring system. The scoring system can, for example, be the EWS system. Further, the parameters related to the scoring system can include, for example, the scoring model. The clinical alarm algorithm is applied 156 to the CMD with the proposed settings for the parameters related to the scoring system.

After performing regeneration, the regeneration results are displayed 158 or evaluated 160. The evaluation can, for example, include determining whether the estimation achieves an objective, such as a target workload. The evaluation results can then be displayed 162. Alternatively, based on the evaluation results, the proposed alarm settings can be revised or tuned and the foregoing can be performed again with the revised or tuned alarm settings. This then repeats until the objective is achieved. With the objective achieved, the regeneration results can be displayed.

In some embodiments, each of the constituent blocks 152, 154, 156, 158, 160, 162 illustrated in FIG. 7 is a means for performing the corresponding functionality. The means for performing the corresponding functionality of each of the blocks 152, 154, 156, 158, 160, 162 includes one of: at least one processor programmed to perform the functionality; an application specific device configured to perform the functionality; and a combination of the at least one processor and an application specific devices coordination to perform the functionality.

As used herein, a memory includes any device or system storing data, such as a random access memory (RAM) or a read-only memory (ROM). Further, as used herein, a processor includes any device or system processing input device to produce output data, such as a microprocessor, a microcontroller, a graphic processing unit (GPU), an application-specific integrated circuit (ASIC), a FPGA, and the like; a controller includes any device or system controlling another device or system, and typically includes at least one processor; a user input device includes any device, such as a mouse or keyboard, allowing a user of the user input device to provide input to another device or system; and a display device includes any device for displaying data, such as a liquid crystal display (LCD) or a light emitting diode (LED) display.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A system for optimization of alarm settings of a clinical alarm algorithm, said system comprising:
an acquisition module configured to acquire clinical monitoring data employed by the clinical alarm algorithm over a user-defined period of time;
a regeneration module configured to:
determine proposed settings for one or more parameters of the clinical alarm algorithm; and
apply the clinical monitoring algorithm to the acquired CMD with the proposed settings to determine regeneration results predicting alarm load for different combinations of the proposed settings.

2. The system according to claim 1, wherein the acquisition module is further configured to:
acquire vital signs and context data as the CMD over a user-defined period of time.

3. The system according to claim 1, wherein the clinical alarm algorithm is a threshold alarm algorithm, wherein the one or more parameters include a threshold of the clinical alarm algorithm, and wherein the regeneration module is further configured to:
apply the clinical monitoring algorithm to the acquired CMD by, for each proposed setting of the threshold, determine a set of intervals during the user-defined period where the acquired CMD exceeds the proposed setting.

4. The system according to claim 3, wherein the one or more parameters further include a delay or inhibition period of the clinical alarm algorithm, and wherein the regeneration module is further configured to:
apply the clinical monitoring algorithm to the acquired CMD by, for each proposed setting of the delay or inhibition period, filter the set of intervals based on the setting.

5. The system according to claim 1, further including:
an alarm module, configured to monitor for patient deterioration through application of the clinical alarm algorithm to CMD, the alarm module coordinating with the regeneration module to predict alarm load.

6. The system according to claim 1, wherein the clinical alarm algorithm is a threshold alarm algorithm employing a scoring system, wherein the one or more parameters includes parameters related to the scoring system, and wherein the regeneration module is further configured to:
apply the clinical monitoring algorithm to the acquired CMD with proposed settings for the parameters related to the scoring system.

7. The system according to claim 6, wherein the scoring system is an early warning score system.

8. The system according to claim 1, further including:
a results analysis module configured to display the regeneration results.

9. The system according to claim 1, further including:
a results analysis module configured to:
evaluate the regeneration results to generate an estimation of workload; and
provide feedback to the regeneration module indicating the estimation does not achieve a target workload; and
wherein the regeneration module is further configured to:
revise the proposed settings based on the feedback; and
apply the clinical monitoring algorithm to the acquired CMD with the revised proposed settings to determine revised regeneration results predicting alarm load for different combinations of the revised proposed settings.

10. The system according to claim 1, further including:
a mobile data recorder including the acquisition module, wherein the acquisition module is configured to store the acquired CMD in a mobile database of the mobile data recorder;
a central data processing system including the regeneration module, the central data processing system configured to download the CMD from the mobile data recorder for use by the regeneration module.

11. A method for optimization of alarm settings of a clinical alarm algorithm, said method comprising:
acquiring clinical monitoring data employed by the clinical alarm algorithm over a user-defined period of time;
determining proposed settings for one or more parameters of the clinical alarm algorithm; and
applying the clinical monitoring algorithm to the acquired CMD with the proposed settings to determine regeneration results predicting alarm load for different combinations of the proposed settings.

12. The method according to claim 11, further including:
acquiring vital signs and context data as the CMD over a user-defined period of time.

13. The method according to claim 11, wherein the clinical alarm algorithm is a threshold alarm algorithm, wherein the one or more parameters include a threshold of the clinical alarm algorithm, and the method further includes:
applying the clinical monitoring algorithm to the acquired CMD by, for each proposed setting of the threshold, determine a set of intervals during the user-defined period where the acquired CMD exceeds the proposed setting.

14. The method according to claim 13, wherein the one or more parameters further include a delay or inhibition period of the clinical alarm algorithm, and wherein the method further includes:
applying the clinical monitoring algorithm to the acquired CMD by, for each proposed setting of the delay or inhibition period, filter the set of intervals based on the setting.

15. The method according to claim 11, wherein the clinical alarm algorithm is a threshold alarm algorithm employing a scoring system, wherein the one or more parameters includes parameters related to the scoring system, and wherein the method further includes:
applying the clinical monitoring algorithm to the acquired CMD with proposed settings for the parameters related to the scoring system.

16. The method according to claim 11, further including: displaying the regeneration results

17. The method according to claim 11, further including at least one of:
displaying the regeneration results and
At least one of:
evaluating the regeneration results to generate an estimation of workload and determine whether the estimation achieve a target workload;
revising the proposed settings in response to the determination; and
applying the clinical monitoring algorithm to the acquired CMD with the revised proposed settings to determine revised regeneration results predicting alarm load for different combinations of the revised proposed settings.

18. (canceled)

19. A non-transitory computer readable medium encoded with instructions for execution by one or more processors for optimization of alarm settings of a clinical alarm algorithm, the non transitory computer readable medium comprising:
instructions for acquiring clinical monitoring data (CMD) employed by the clinical alarm algorithm over a user-defined period of time;
instructions for determining proposed settings for one or more parameters of the clinical alarm algorithm; and
instructions for applying the clinical monitoring algorithm to the acquired CMD with the proposed settings to determine regeneration results predicting alarm load for different combinations or the proposed settings.

20. (canceled)

21. The non-transitory computer readable medium of claim 19, further comprising:
instructions for acquiring vital signs and context data as the CMD over a user-defined period of time.

22. The non-transitory computer readable medium of claim 19, wherein the clinical alarm algorithm is a threshold alarm algorithm, wherein the one or more parameters include a threshold of the clinical alarm algorithm, and the non-transitory computer readable medium further comprises:
instructions for applying the clinical monitoring algorithm to the acquired CMD by, for each proposed setting of the threshold, determine a set of intervals during the user-defined period where the acquired CMD exceeds the proposed setting.
